(19) United States
(12) Patent Application Publication
(10) Pub. No.: US 2009/0218066 A1
(43) Pub. Date: Sep. 3, 2009

(54) WATER-BASED WASH CONTAINING A NUCLEATING AGENT

(75) Inventors: Reinhard Stötzel, Borken (DE); Ernst Weiser, Unterneukirchen (DE)

Correspondence Address: SCOTT R. COX;LYNCH, COX, GILMAN & MAHAN, P.S.C., 500 WEST JEFFERSON STREET, SUITE 2100, LOUISVILLE, KY, 40202, US

(73) Assignee: ASHLAND-SUDCHEMIE-KERNFEST GMBH, Hilden (DE)

(21) Appl. No.: 12/160,943

(22) PCT Filed: Jan. 7, 2007
(86) PCT No.: PCT/EP2007/000076

§ 371 Date: Nov. 25, 2008

(30) Foreign Application Priority Data
Jan. 17, 2006 (DE) 10 2006 002 246.7

(51) Int. Cl. B22C 9/12; B22C 3/00; C04B 41/50; C08L 1/10; C08L 1/02; C09D 189/00; C09D 105/12; C08K 3/08

(52) U.S. Cl. 164/72; 249/114.1; 106/287.1; 106/170.57; 106/204.3; 106/157.7; 106/205.9; 524/440

(57) ABSTRACT

The invention relates to a wash which is suitable, in particular, for centrifugal casting. The wash comprises at least:
a carrier liquid;
at least one pulverant refractory material;
at least one thickener; and
a metallic nucleating agent which can initiate crystallization of the metal used for casting.

The invention further relates to a process for producing a casting and a casting mold which comprises a mold coating produced from the wash of the invention.

The invention relates to a wash which is particularly suitable for centrifugal casting, a process for producing a casting and also a casting mold having a mold coating.

Most products of the iron and steel industry and also of the nonferrous metals industry go through casting processes for initial shaping. Here, the molten materials, ferrous metals or nonferrous metals are converted into articles having a particular geometry and having particular workpiece properties. To produce the shaped castings, it is necessary firstly to produce sometimes very complicated casting molds for accommodating the melt. The casting molds are divided into lost molds which are destroyed after each casting and permanent molds by means of which a large number of castings can be produced.

Lost molds usually comprise a mineral, refractory, particulate mold material which is often admixed with various further additives, e.g. to achieve good cast surfaces, and which is held together by means of a binder. Washed, classified silica sand is usually used as refractory, particulate mold material. For particular applications in which particular requirements have to be met, chromite, zircon and olivine sand are also used. In addition, mold materials based on chamotte or magnesite, silimanite or α-alumina are also utilized. The binders by means of which the mold materials are held together can be inorganic or organic in nature. Small lost molds are predominantly produced from mold materials which are bound by means of bentonite as binder, while organic polymers are usually used as binders for large molds. The casting molds are usually produced by firstly mixing the mold material with the binder so that the particles of the mold material are coated with a thin film of the binder. This mold material mixture is then introduced into an appropriate mold and, if appropriate, densified to achieve sufficient mechanical stability of the casting mold. The casting mold is subsequently cured, for example by heating it or by adding a catalyst which brings about a curing reaction. When the casting mold has achieved a sufficient initial strength, it can be removed from the mold and transferred, for example, to an oven in which it is heated to a particular temperature for a predetermined time in order to effect complete curing.

Permanent molds are used for producing many castings. They therefore have to survive the casting process and the stresses associated therewith out damage. Materials which have proven to be useful for permanent molds are, in particular, cast iron and unalloyed steels and alloy steels and also copper, aluminum, graphite, sintered metals and ceramic materials, depending on the application. Permanent mold processes include chill casting, pressure casting, centrifugal casting and continuous casting processes.

Casting molds are subjected to very high thermal and mechanical stresses during casting. Defects can therefore arise at the contact interface between liquid metal and casting mold, for example the casting mold can rupture or liquid metal can penetrate into the microstructure of the casting mold. For this reason, the surfaces of the casting mold which come into contact with the liquid metal are usually provided with a protective coating, which is also referred to as a wash. Such a wash usually comprises an inorganic refractory material and a binder, which are dissolved or slurried in a suitable solvent, for example water or alcohol.

These coatings thus enable the surface of the casting mold to be modified and matched to the properties of the metal to be processed. Thus, the wash can enable the appearance of the casting to be improved by producing a smooth surface, since the wash evens out irregularities caused by the size of the grains of the mold material. Furthermore, the wash can influence the casting metallurgically by, for example, additives which improve the surface properties of the casting being transferred into the casting selectively on the surface of the casting by means of the wash. Furthermore, the washes form a layer which chemically isolates the casting mold during casting of liquid metal. In this way, adhesion between casting and casting mold is prevented, so that the casting can be removed without difficulty from the casting mold. In addition, the wash ensures thermal separation of casting mold and casting. This is particularly important in the case of permanent molds. If this function is not performed, a metal mold, for example, experiences such high thermal stresses during the course of successive casting operations that it is destroyed prematurely. However, the wash can also be used to control heat transfer between liquid metal and casting mold in a targeted manner in order to bring about, for example, formation of a particular metal microstructure by means of the cooling rate.

The washes usually used contain, for example, clays, silica, kieselguhr, cristobalite, tridymite, aluminum silicate, zirconium silicate, mica, chamotte or coke or graphite as base materials. These base materials cover the surface of the casting mold and close the pores to prevent intrusion of the liquid metal into the casting mold. Owing to their high insulating capability, use is frequently made of washes which contain silicon dioxide or kieselguhr as base materials, since these washes can be produced cheaply and are available in large quantities.

Important processes for producing metal parts, for example parts made of cast iron, are the large-part casting process and the centrifugal casting process.

In the large-part casting process, in which relatively large castings are produced, lost molds are usually used. The size of the castings to be produced results in very large metallostatic pressures being exerted on the casting mold. Due to the long cooling times, the casting mold is also subjected to a high thermal stress over very long periods of time. In this process, the wash performs a pronounced protective function to prevent penetration of the metal into the material of the casting mold, rupture of the casting mold (formation of flash) or reaction between metal and the material of the casting mold (burning-in).

In centrifugal casting, the liquid metal is introduced into a tubular or annular mold rotating about its axis and the metal is shaped in this mold under the action of centrifugal force to produce, for example, bushings, rings and tubes. It is absolutely necessary for the casting to be completely solidified before removal from the casting mold. There are therefore fairly long contact times between casting mold and casting, during which the casting mold must not be adversely affected by the cooling casting. The casting molds are in this case designed as permanent molds, i.e. the casting mold must not change its properties and its shape as a result of the casting process even after the stress exerted. In centrifugal casting, the casting mold is therefore coated with an insulating wash which is applied in a single layer or in the form of multiple layers.

At present, essentially three processes are employed for the manufacture of centrifugally cast tubes. In the first process, a powder wash which comprises a nucleating agent and graphite and sometimes also proportions of aluminum is used. This wash is distributed in the rotating mold by means of a tube which is cut open and filled with the powder wash. For this purpose, the tube filled with the powder wash is firstly inserted into the mold by an appropriately trained person and then slowly withdrawn from the mold again, with the tube being rotated about its longitudinal axis so that the powder wash falls out from the tube. A disadvantage of this process is that the powder wash cannot be applied by machine in an automated process and the application of the powder wash therefore does not occur reproducibly and absolutely uniformly. This results in quality fluctuations in the finished casting, which have to be compensated by means of appropriate final machining. A further process uses a ready-made water-based wash in which zirconium silicate, aluminum silicate and/or aluminum oxide is suspended as refractory material. This wash is sprayed from a pressure vessel onto the hot rotating mold in one or more steps by means of a spray lance having a spray nozzle or flooding nozzle. A further process uses an aqueous wash which consists essentially of calcined kieselguhr, bentonite and water.

The centrifugal casting washes which are mostly used nowadays are based on kieselguhr. However, the rotational motion of the casting mold during centrifugal application and the after-machining of the casting frequently leads to part of the wash getting into the environment as dust or aerosol. These dusts, which contain kieselguhr, calcined kieselguhr and products formed in the calcination of kieselguhr, e.g. cristobalite, are now classified as causing silicosis and also as carcinogenic. This results in a high hazard potential for operating personnel. There is therefore a great need for alternative compositions for washes which are firstly highly insulating and secondly refractory.

GB 818,165 describes a semiautomatic apparatus for the mass production of cylinder liners for internal combustion engines by centrifugal casting. The apparatus comprises a station in which the molds are coated by means of a spray apparatus, with the spray apparatus being moved in and out of the mold by means of an appropriate apparatus. A wash proposed is, for example, a silicate solution.

GB 722,459 describes a mold for centrifugal casting which has a refractory insulating coating on its interior surface. The coating is applied to the internal surface of the mold by setting the latter into rotation and introducing an aqueous wash into the mold by means of a spray apparatus. The wash comprises a refractory material, a clay as binder and a wetting agent which reduces the surface tension of water. This improves the homogeneity of the wash and as a consequence the binder is distributed more uniformly on the particles of the refractory material, so that the coating becomes stronger. The surface of the coating is essentially smooth and has many small depressions which extend outward in the radial direction into the coating. When liquid metal is introduced into the rotating mold, it penetrates into the depressions of the coating and solidifies very rapidly there. As a result, the molten metal quickly becomes anchored on the surface of the coating and acquires the rotational motion of the mold, so that the centrifugal force acts relatively quickly on the metal and therefore distributes it uniformly along the wall of the mold. The mold is firstly heated so that the water present in the wash evaporates very quickly when the wash is sprayed onto the surface of the mold. On withdrawal of the casting, the coating of the mold is ejected together with the casting, with the coating adhering firmly to the outside of the casting. Bentonite is preferably used as binder. As refractory material, the wash preferably contains pulverant silicon dioxide. As wetting agent, it is possible to use, for example, sodium lauryl sulfate. The coating produced from the wash has a strongly insulating effect, so that the liquid metal is cooled slowly and casting defects are avoided.

FR 2 829 048 describes a wash composition which contains metakaolin as refractory material, at least one binder, a solvent and a wetting agent. The wash further comprises a blowing agent to increase the porosity of the coating.

EP 0 806 258 B1 describes a process for producing an insulating coating for metal molds for the casting of iron-containing metals, which process is particularly suitable for centrifugal casting. At least one base coating is applied to the surface of the casting mold and this base coating remains continually in the mold. A top coating is applied to the base coating, and this is partly or completely renewed after each casting operation. The top coating contains metakaolin.

GB 868,959 describes a centrifugal casting process in which a thin coating of an essentially dry finely divided silicon dioxide powder is applied in a thickness of less than 0.1 mm to the interior surface of the rotating casting mold. The silicon dioxide particles have an elongated shape, with the greatest diameter being in the range from 0.03 to 0.09 mm. The coating is applied to the interior surface of the casting mold by means of compressed air while the casting mold rotates at the frequency which is subsequently also employed during centrifugal casting. Due to the high velocity of the particles and the action of the centrifugal force, a thin layer of silicon dioxide particles which adhere firmly to the interior wall of the mold is formed. At the same time, irregularities on the surface of the casting mold are evened out by the coating. After the coating has been applied, the casting mold is kept rotating and liquid metal is introduced into the casting mold. The coating effects thermal insulation of the casting mold from the liquid metal, so that thermal shock is reduced. After solidification, the tubes can be withdrawn easily from the casting mold and have a very good quality of the surface. In the process described in GB 868,959, the binder is applied dry and does not contain any binder, so that the liquid iron can be introduced into the mold immediately after application of the coating.

GB 865,301 describes a process for lining a casting mold for centrifugal casting with a coating. The coating is produced by applying a plurality of layers of a mixture of a silicon dioxide powder and bentonite suspended in water to the surface of the casting mold. Here, a first layer which has an essentially smooth surface and a uniform thickness is firstly applied. After the layer has dried, a further layer which has a rough surface is applied. Before casting of the casting, a very thin layer of a pulverant product such as calcium silicide, calcium ferrosilicide, etc., which act as crystallization nuclei for formation of the desired crystal microstructure is applied to the surface of the coating.

DE 30 09 490 A1 describes a wash for lining a metal centrifugal casting mold for copper or its alloys and a process for applying it. The wash consists essentially of titanium dioxide which is slurried in a dispersion medium which evaporates without leaving a residue, in particular water. To apply the wash, the mold is firstly preheated and the wash is sprayed as binder-free and wetting agent-free suspension in the form of a very uniform thin layer onto the interior wall of the mold which is rotating about its axis. The dispersion medium of the wash is evaporated without leaving a residue, so that the coating acquires a porous structure. The coating can be sprayed on in a plurality of steps, for which purpose the spray head is moved back and forth a number of times within the rotating mold, with the previously sprayed-on layer being allowed to dry before the next layer is sprayed on.

An important problem which has to be solved in centrifugal casting is the production of a particular metal microstructure so that the casting has the desired properties. In centrifugal casting, the casting mold is firstly brought to a particular temperature. This can be effected by heating at the beginning of a process or during continuous production by means of the heat of the preceding casting operation. Liquid metal is introduced into the rotating casting mold. The metal undergoes rapid cooling and solidifies. Solidification can result in formation of an undesirable microstructure which adversely affects the properties of the casting. Thus, for example, white solidification can occur in the production of gray cast iron. The outer layer of the casting becomes very hard and brittle and can therefore be machined only with difficulty. For this reason, nucleating agents are used to obtain the correct microstructure on solidification of the metal. These are introduced into the rotating mold before introduction of the liquid metal. However, the amount of nucleating agent introduced into the mold is difficult to control. In general, a tube which is open at the front and filled with the pulverant nucleating agent is used. The tube is inserted into the mold by an operator and is then pulled out while being rotated, so that the pulverant nucleating agent comes out of the tube and is distributed in the mold. However, this distribution is inevitably somewhat irregular and is therefore not reproducible.

As alternatives, insulating protective layers are applied to the interior wall of the mold. As a result, the metal cools more slowly when it impinges on the mold wall, so that the desired microstructure can be formed. In this mode of operation, the mold is subjected to reduced thermal shock so that it is less subject to wear. However, the insulating action is generally insufficient, so in this case, too, nucleating agent is additionally applied to the coating. Here too, difficulties with metering occur. This is particularly disadvantageous since the nucleating agents are relatively expensive and therefore should where possible be introduced into the mold only in the smallest amount required.

It is therefore an object of the invention to provide a wash which is suitable for, in particular, centrifugal casting and has a positive influence on the properties of the casting obtained during casting, in particular reliably brings about initiation of the desired metal microstructure. In addition, the wash should allow the automatic and reproducible production of a protective coating which makes reliable and reproducible initiation of the metal microstructure possible.

This objective is achieved by a wash having the features of claim 1. Advantageous embodiments of the wash of the invention are subject matter of the dependant claims.

The wash of the invention, which is particularly suitable for centrifugal casting, comprises at least:
a carrier liquid;
at least one pulverant refractory material;
at least one thickener; and
a metallic nucleating agent which can initiate crystallization of the metal used for casting.

The wash of the invention contains a metallic nucleating agent which can initiate crystallization or microstructure formation during casting of the metal in addition to a refractory material. The wash of the invention therefore combines two effects: firstly, an insulating protective layer can be produced in or on the casting mold by means of the pulverant refractory material. Secondly, the wash already contains the nucleating agent so that crystallization nuclei are provided in the casting mold when the protective coating is produced and it is no longer necessary to introduce the nucleating agent into the casting mold in a separate step. The wash of the invention forms a suspension, i.e. it can be applied automatically to the casting mold by means of an appropriate spray apparatus. As a result, production of the protective layer can be carried out in an automated fashion, or reproducibly. The wash further comprises a thickener which prevents settling of the metallic nucleating agent. The metallic nucleating agent is therefore distributed approximately homogeneously in the wash and is therefore also applied uniformly to the wall of the casting mold. In this way, the amount of metallic nucleating agent which is applied to the surface of the casting mold can be controlled very precisely and it is possible to achieve a significant reduction in the amount of the metallic nucleating agent which is necessary for reliable microstructure formation, compared to manual application of the nucleating agent.

The wash comprises firstly a carrier liquid in which the further constituents of the wash can be suspended or dissolved. This carrier liquid is appropriately selected so that it can be evaporated completely under the conditions customary in metal casting. The carrier liquid should therefore have a boiling point at atmospheric pressure of less than about 130° C., preferably less than 110° C. As carrier liquid, preference is given to using water or an alcohol such as ethanol or isopropanol or a mixture of these carrier liquids. At least one pulverant refractory material is suspended in the carrier liquid. As refractory material, it is possible to use refractory materials which are customary in metal casting. Examples of suitable refractory materials are silica, aluminum oxide, aluminum silicates such as pyrophyllite, kyanite, andalusite or chamotte, zircon sands, olivine, talc, mica, graphite, coke, feldspar. The refractory material is made available in powder form. The particle size is selected so that a stable microstructure is formed in the coating and so that the wash can be distributed without problems on the wall of the casting mold by means of the spray apparatus. The refractory material appropriately has an average particle size in the range from 0.1 to 500 μm, particularly preferably in the range from 1 to 200 μm. Suitable refractory materials are, in particular, materials which have a melting point which is at least 200° C. above the temperature of the liquid metal and do not undergo any reaction with the metal.

The wash of the invention further comprises at least one thickener. The thickener increases the viscosity of the wash, so that the solid constituents of the wash do not settle or settle to only a small extent in the suspension. To increase the viscosity, it is possible to use either organic or inorganic materials or mixtures of these materials. Suitable inorganic thickeners are, for example, strongly swellable clays.

Possible organic thickeners are, for example, swellable polymers such as carboxymethylcellulose, methylcellulose, ethylcellulose, hydroxyethylcellulose and hydroxypropylcellulose, plant mucilages, polyvinyl alcohols, polyvinylpyrrolidone, pectin, gelatin, agar agar and polypeptides and also alginates.

The wash of the invention further comprises a metallic nucleating agent. This nucleating agent is selected according to the metal which is used for casting. As nucleating agents, it is possible to use the materials which have hitherto also been used as nucleating materials.

In a preferred embodiment, the wash of the invention comprises at least one binder as further constituent. The binder makes better fixing of the wash or the protective coating produced from the wash on the wall of the casting mold possible. In addition, the binder increases the mechanical stability of the protective coating, so that less erosion under the action of the liquid metal is observed. As binders, it is possible to use customary binders such as clays, in particular bentonite.

The wash of the invention can, in a preferred embodiment, have such a composition that it is suitable, in particular, for casting of iron. As nucleating agent, preference is given to using an iron-containing alloy. The proportion of iron in the alloy is preferably from 5 to 60% by weight, particularly preferably from 8 to 30% by weight.

As iron-containing alloy, preference is given to using a ferrosilicon alloy. The proportion of silicon in the ferrosilicon alloy is preferably in the range from 20 to 80% by weight, particularly preferably from 50 to 70% by weight.

The nucleating agent preferably has a particle size of less than 0.5 mm. The nucleating agents introduced into the wash of the invention usually have a relatively high density and therefore settle quickly in the wash. Although this settling is reduced by the thickener, making the particle size smaller can further reduce the settling of the nucleating agent so that the nucleating agent remains homogeneously suspended in the wash. A further advantage is that, when a spray apparatus is used for applying the wash, the nozzle of the spray apparatus is less prone to becoming blocked when a nucleating agent having a small particle size is used. The nucleating agent particularly preferably has an average particle size of less than 0.3 mm. However, if the particle size is too small, difficulties with the nucleating action can occur. Furthermore, as the particle size decreases, the specific surface area of the nucleating agent increases and its reactivity with the liquid present in the wash, for example water, also increases. In the case of a reaction of the nucleating agent with, for example, water, gas formation is observed and this leads to foaming. The wash can therefore no longer be reliably pumped or sprayed. The average particle size is therefore preferably greater than 50 μm, particularly preferably greater than 80 μm. Particular preference is given to using a nucleating agent having a particle size in the range from 80 to 300 μm.

In a preferred embodiment, the nucleating agent or the ferrosilicon alloy can also contain further alloying constituents which have a positive influence on the properties of the nucleating agent. In one embodiment of the wash of the invention, the nucleating agent comprises a proportion of aluminum in the range from 2 to 8% by weight, preferably from 3 to 6% by weight, particularly preferably from 3 to 5% by weight.

The metallic nucleating agent can also contain further alloying constituents which can be selected, for example, from among cerium, magnesium, chromium, molybdenum. The proportions of these alloying constituents are preferably in the range from 0.01 to 2% by weight, preferably from 0.1 to 1% by weight, based on the metallic nucleating agent. The metallic nucleating agent can also contain calcium as further alloying constituent. The calcium content is in this case preferably in the range from 0.2 to 2% by weight, particularly preferably from 0.5 to 1.5% by weight.

The nucleating agent is generally added in an amount corresponding to from 0.1 to 0.3% by weight based on the metal which is cast. Based on the wash of the invention, the proportion of nucleating agent is preferably in the range from 0.2 to 40% by weight, particularly preferably from 1 to 30% by weight and very particularly preferably from 1.5 to 20% by weight.

As discussed above, the wash of the invention comprises a thickener which prevents settling of the metallic nucleating agent. The thickener is preferably selected from among organic thickeners and sheet silicates which exhibit a high degree of swelling. The organic thickeners or the sheet silicates exhibiting a high degree of swelling are selected so that a significant increase in the viscosity is achieved even at a small added amount.

Organic thickeners are preferably chosen as thickeners since they can be dried after application of the protective coating to such an extent that they release barely any water on contact with the liquid metal. Preferred organic thickeners are, for example, selected from the group consisting of carboxymethylcellulose, alginates, ethylcellulose, pectin, gelatin, agar agar and polypeptides.

As sheet silicate exhibiting a high degree of swelling, it is possible to use either two-layer silicates or three-layer silicates, for example attapulgite, serpentines, kaolins, smectites such as saponite, montmorillonite, beidellite and nontronite, vermiculite, illite, hectorite and mica. Hectorite also gives the wash thixotropic properties, which aids the formation of the protective layer on the casting mold since the wash no longer flows after application. Since sheet silicates contain intercalated water which does not vaporize when the wash is applied to the hot casting mold which is at a temperature in the range from about 250 to 350° C., the amount of clay is preferably very low. The amount of sheet silicate exhibiting a high degree of swelling is preferably selected in the range from 0.01 to 5.0% by weight, particularly preferably in the range from 0.1 to 1.0% by weight, based on the weight of the wash.

In a particularly preferred embodiment, the wash of the invention contains silica sol as binder. The proportion of the binder is preferably selected in the range from 0.1 to 20% by weight, particularly preferably from 0.5 to 5% by weight, based on the weight of the wash. The silica sol is preferably produced by neutralization of water glass. The amorphous silica present in the sol preferably has a specific surface area in the range from 10 to 1000 m²/g, particularly preferably in the range from 30 to 300 m²/g.

Particularly when water is used as dispersion liquid, the metallic nucleating agent tends to react with the water. In a preferred embodiment, the iron-containing alloy is preimpregnated with phosphoric acid. Gas formation can be suppressed virtually completely by the iron phosphate formed, so that the wash can also be stored over prolonged periods of time.

To prevent settling of the solid constituents of the wash and at the same time enable uniform application to the casting mold to be achieved, the viscosity of the wash is preferably selected in the range from 1000 to 3000 mPas, particularly preferably from 1200 to 2000 mPas.

In a further preferred embodiment, the wash contains a proportion of graphite. This aids the formation of lamellar carbon at the interface between casting and casting mold. The proportion of graphite is preferably selected in the range from 1 to 30% by weight, particularly preferably from 5 to 15% by weight, based on the weight of the wash.

The invention further provides a process for producing a casting using the above-described wash.

In the process of the invention, a casting mold is firstly provided. This can be either a lost mold which has been produced in a customary manner from a refractory material, for example silica sand, and a binder or a permanent mold as is customarily used for producing tubes, bearings or bushings.

The casting mold is then coated with a wash as described above, so that a protective coating is obtained. Customary methods can be used for this purpose. The wash can be applied by dipping processes, brushing-on or preferably by spraying-on. The carrier liquid present in the wash is subsequently vaporized. This can be effected using the heat which has remained in the casting mold from the preceding casting operation. However, it is also possible to heat the casting mold appropriately. The casting mold then has a protective coating which insulates the liquid metal from the casting mold and can initiate microstructure formation in the solidifying metal on at least the surfaces which come into contact with the liquid metal. Liquid metal, preferably iron or an iron alloy, is then introduced into the prepared casting mold. The liquid metal is subsequently allowed to solidify to form a casting and the casting is then separated from the casting mold. Customary methods can be employed for this purpose. In the case of lost molds, customary methods are employed. In the case of lost molds, the casting mold is mechanically broken, for example by shaking. In the case of permanent molds, the casting is withdrawn from the casting mold by customary methods.

The process is particularly suitable for centrifugal casting in which the liquid metal is applied to the inside of the casting mold by centrifugation. To achieve this, the casting mold is set into rotation about its axis in a customary fashion and the liquid metal is then introduced into the permanent mold.

The above-described wash is preferably introduced into the rotating permanent mold since it makes uniform distribution of the wash over the interior wall of the permanent mold possible. For this purpose, the wash is particularly preferably sprayed onto the interior wall of the permanent mold by means of a suitable spray apparatus. This procedure can advantageously be automated, so that reproducible layer thicknesses of the protective layer can be provided.

The invention further provides a casting mold which has a mold coating produced from the above-described wash. Such a casting mold advantageously has insulation between the liquid metal and the casting mold, by means of which the thermal stress on the casting mold during the casting operation is reduced and the durability of the casting mold is therefore increased. As a further advantage, the mold coating has nucleating crystals which can initiate the microstructure formation on solidification of the liquid metal.

The invention is illustrated below with the aid of examples.

### EXAMPLE 1

As nucleating agent, use was made of the nucleating agent VP 216 from SKW Gieβerei-Technik GmbH, D-84579 Unterneukirchen. The nucleating agent contains from 68 to 73% by weight of silicon, from 3.2 to 4.5% by weight of aluminum and from 0.3 to 1.5% by weight of calcium, with the balance being iron. The nucleating agent had a particle size of from 80 to 300 μm.

The nucleating agent VP 216 was stirred into a wash which had been produced from the composition shown in table 1.

TABLE 1
Composition of the wash

| | |
|---|---|
| Water | 27.4 kg |
| Hectorite | 0.2 kg |
| Carboxymethylcellulose | 0.2 kg |
| Biocide | 0.2 kg |
| Chamotte | 50.0 kg |
| Silica | 5.0 kg |
| Aluminum oxide | 15.0 kg |
| Silica sol | 2.0 kg |

The wash indicated in table 1 was diluted with water to a solids content of 33%. The diluted wash had a viscosity of 1300 mPas, measured by means of a Brookfield DV II Pro+instrument, 20 rpm, spindle 4, using a method based on DIN 53019.

The wash was admixed with 28% by weight of a nucleating agent mixture consisting of 50% of nucleating agent VP 216 and 50% of electrodegraphite (particle size<0.2 mm), with the nucleating agent being added while stirring vigorously.

For comparison, the mold was coated with the same diluted wash to which no nucleating agent had been added.

The washes were each applied to the interior surface of a rotating mold which was at a temperature of about 350° C. by means of a spray lance (1.8 mm spray head diameter, pressure: 1-2 bar, 2 strokes). Two strokes with the spray lance were performed, which gave a layer thickness of the mold coating of about 200-300 μm. A liquid iron alloy (for composition, see table 2) was subsequently introduced into the prepared mold (melt temperature 1630° C., casting 1580-1600° C., mold temperature during casting: 1500-1530° C.). 30 tubes having an external diameter of 52 mm, an internal diameter of 28 mm and a length of 500 mm were obtained in each case. After cooling, the tubes were withdrawn from the mold and the surface was examined for white solidification.

TABLE 2
composition of the iron alloy

| Constituent | % by weight |
|---|---|
| Carbon | 3.30-3.50% by weight |
| Silicon | 1.90-2.20% by weight |
| Sulfur | 0.025-0.30% by weight |
| Iron | to 100% by weight |

In the case of the tube produced using the wash of the invention, white solidification was observed only on the first 4-5 cm measured from the point of introduction of the metal. In the case of the comparative example, i.e. tubes obtained without addition of a nucleating agent, white solidification was observed over the entire length of the tubes.

1. A wash, in particular for centrifugal casting, comprising at least:
a carrier liquid;
at least one pulverant refractory material;
at least one thickener; and
a metallic nucleating agent which can initiate crystallization of the metal used for casting, wherein the nucleating agent comprises an iron containing alloy, which comprises from 20% to 80% by weight of silicon, from 2 to 8% by weight of aluminum, and from 0.2 to 2% by weight calcium.

2. The wash as claimed in claim 1, wherein the wash further comprises at least one binder.

3. (canceled)

4. The wash as claimed in claim 1, wherein the iron-containing alloy comprises a ferrosilicon alloy.

5. (canceled)

6. The wash as claimed in claim 1, wherein the nucleating agent has a particle size of less than 0.5 mm.

7. (canceled)

8. The wash as claimed in claim 3, wherein the metallic nucleating agent further comprises at least one further alloying constituent selected from among cerium, magnesium, chromium, and molybdenum.

9. The wash as claimed in claim 1, wherein the proportion of nucleating agent, based on the weight of the wash, is in the range from 0.2 to 40% by weight.

10. The wash as claimed in claim 1, wherein the at least one thickener is selected from the group consisting of organic thickeners and sheet silicates which display a high degree of swelling.

11. The wash as claimed in claim 10, wherein the organic thickener is selected from the group consisting of carboxymethylcellulose, methylcellulose, ethylcellulose, hydroxyethylcellulose and hydroxypropylcellulose, plant mucilages, alginates, polyvinyl alcohols, polyvinyl-pyrrolidone, ethylcellulose, pectin, gelatin, agar agar and polypeptides.

12. The wash as claimed in claim 10, wherein the sheet silicate is selected from the group consisting of hectorite, attapulgite, serpentines, kaolins, smectites such as saponite, montmorillonite, beidellite and nontronite, vermiculite, illite, hectorite and mica.

13. The wash as claimed in claim 2, wherein the binder comprises a silica sol.

14. The wash as claimed in claim 1, wherein the iron-containing alloy has been preimpregnated by means of phosphoric acid.

15. The wash as claimed in claim 1, wherein the wash has a viscosity in the range from 1000 to 3000 mPas.

16. The wash as claimed in claim 1, wherein the wash further comprises graphite.

17. A process for producing a casting, comprising
providing a casting mold,
casting the casting mold with the wash, as claimed in claim 1;
introducing liquid metal into the casting mold,
solidifying the liquid metal to form a casting, and
separating the casting from the casting mold.

18. The process as claimed in claim 17, wherein the wash and/or the liquid metal are/is applied to the inside of the casting mold by centrifugation.

19. The process as claimed in claim 17, wherein the wash is applied to the inside of the casting mold by spraying.

20. A casting mold comprising a mold coating produced from a wash as claimed in claim 1.

21. The wash as claimed in claim 1 wherein the iron containing alloy comprises from 50 to 70% by weight silicon.
